(19) United States
(12) Patent Application Publication
(10) Pub. No.: US 2001/0046412 A1
(43) Pub. Date: Nov. 29, 2001

(54) Mechanical joint

(75) Inventor: Mark Nicholas Johnson, North Yorkshire (GB)

Correspondence Address: HEAD JOHNSON & KACHIGIAN, 228 W 17TH PLACE, TULSA, OK, 74119, US

(73) Assignee: Stage One Creative Service, Ltd.

(21) Appl. No.: 09/864,694

(22) Filed: May 24, 2001

(30) Foreign Application Priority Data
May 25, 2000 (GB) 0012653.2

(51) Int. Cl. F16B 2/14; F16B 2/18; B25G 3/20; F16B 7/04

(52) U.S. Cl. 403/374.1

(57) ABSTRACT

The invention relates to the provision of a mechanical joint, a method for forming the same and items made incorporating the joint. The joint includes a first member with an opening which is in an initially sufficiently wide condition to receive therein a second member, insert or former. When the same is positioned correctly the opening is moved to a condition whereby the insert, second member or former is trapped in the opening. By this method the second and first members are connected either directly or via connection to the insert or former. Items including a plurality of said joints at the required locations can be made which are strong and sturdy and with relatively straightforward manufacturing requirements.

The invention to which this application relates is a mechanical joint which can be used in many possible areas such as, for example, in construction of furniture, exhibition stands, staging and the like.

Conventionally, when an item such as an item of furniture or staging is constructed, at various intervals such as at the corners of the item a series of members are joined together typically by welding. For example, the ends of an end member and side member are abutted against a leg member and welded thereto to form part of the frame construction. In other instances, the leg member can be provided with slots or other engagement means to allow matching engagement means in the end and side members to be engaged therewith but again, typically, some form of welding or other attachment is also provided to ensure that the members stay in the correct position. The use of welding to join the members together means that once the item has been formed, finishing operations are required to reduce the visible impact of the join and smooth the surfaces of the same. However, it is still commonly the case that the attachment technique used is clearly visible and this can detract from the aesthetic appearance of the article and, furthermore, can also restrict the form and construction of the articles.

The aim of the present invention is to provide a mechanical joint which can be used without the need for visible attachment means thereby improving the aesthetic appearance of the articles formed using this type of joint.

In a first aspect of the invention there is provided a mechanical joint for use in the construction of an article, said joint comprising a first member for connection with a second member, and wherein said first member is provided with at least one aperture having an opening defined by first and second edges, said aperture provided for the reception of the second member, or an insert to which the second member can be attached, and to form the joint, the first and/or second edges of the opening are moved to engage the second member or insert within the aperture.

In one embodiment the first member is provided with a series of apertures formed at spaced intervals and each of said apertures is provided for the formation of a mechanical joint in accordance with the invention.

Typically the second member lies in a plane substantially perpendicular to the plane of the longitudinal axis of the first member.

In one embodiment, the first member is provided in an initial condition in an elongate form and the movement of the first and second edges of the opening of the aperture is about a pivotal axis located in the aperture or adjacent thereto so that the first member, when the joint is formed has relatively angled first and second portions adjacent the joint.

In one embodiment, the aperture is formed so as to extend from one side of the member across the majority of the member to the opposite side leaving a band of material at the opposite side.

In one embodiment, the said first member includes engagement means at intervals, or along the length thereof, to allow the engagement of a further component such as, for example, a table top, decking or the like.

In a further aspect of the invention there is provided a method of forming a mechanical joint, said method comprising taking a first elongate member, forming an aperture depending from one edge of said member, positioning a member or insert in the aperture and then moving at least one portion of the member to move first and second edges of the opening into the aperture towards one another to a degree which is sufficient to prevent the insert or member from passing through the opening.

In one embodiment the first and second edges are respectively moved so as to substantially close the opening and hence retain the member or insert in position in the aperture. In one arrangement the opening may be completely closed by the provision of a closing member and/or weld material.

In one embodiment an insert is provided in the aperture and has upper and/or lower collars formations which protrude above or below the first member. In one form the member positioned in the aperture is a former and is subsequently moved out of the aperture and replaced by an insert which can be held in position or alternatively the member is a second member which is attached via the mechanical joint. In an alternative embodiment, the insert is provided in the aperture and when the first member is moved, as described, the insert in position so there is no need for a further insert or member to be provided.

If an insert is used, typically it is provided with engagement means to allow the engagement of a second member therewith.

It will therefore be appreciated that a number of these mechanical joints and a number of members can be provided to allow the formation of an item.

In one embodiment, if the item which is formed is for example a table or desk or staging or a stand, the sheet material which forms the table top or stage is formed of a particular shape and at least partially enclosed by at least one member in which the mechanical joints are to be formed. The at least one member is provided with engagement means for the sheet material. In one embodiment, in the formation of the item, the mechanical joints are formed with the sheet material in situ so that the at least one member is formed around the sheet material to take the same shape as the outline of the sheet material.

It should also be appreciated that in some instances, and dependent on the size and form of aperture in the member, the insert or second member which is to be located in the aperture may be of a size or diameter greater than the dimensions of the member in which the aperture is formed so that the mechanical joint has a bulbous form.

In a yet further aspect of the invention there is provided a method of forming a mechanical joint, said method comprising taking a first elongate member, forming an aperture depending from one edge of said member, positioning a former in the aperture and moving at least one portion of the member to at least partially close the opening to an extent which is sufficient to prevent the former from passing through the opening.

In one embodiment the former is removed by sliding the same out of the aperture and replaced by an insert or second member which is positioned to engage in the opening and so engage a second member with the first member directly or via the insert.

In an alternative embodiment the former is an insert which is retained in position and to which the second member is connected or the former is the second member itself which is trapped in position to form the mechanical joint.

In a further aspect of the invention there is provided an item formed from at least a first and second member, said item formed by engaging the second member with the first member via a mechanical joint and characterised in that said mechanical joint is formed with the first member including an opening defined therein for the reception of the second member or means to which the second member can be attached, said edges defining the opening moved to trap the means or second member in the opening and thereby form the item of furniture.

In one embodiment the item is formed from a series of selectively engaged members, at least one of said engagements made via a mechanical joint as herein described.

Specific embodiments of the invention will now be described with reference to the accompanying drawings, wherein:

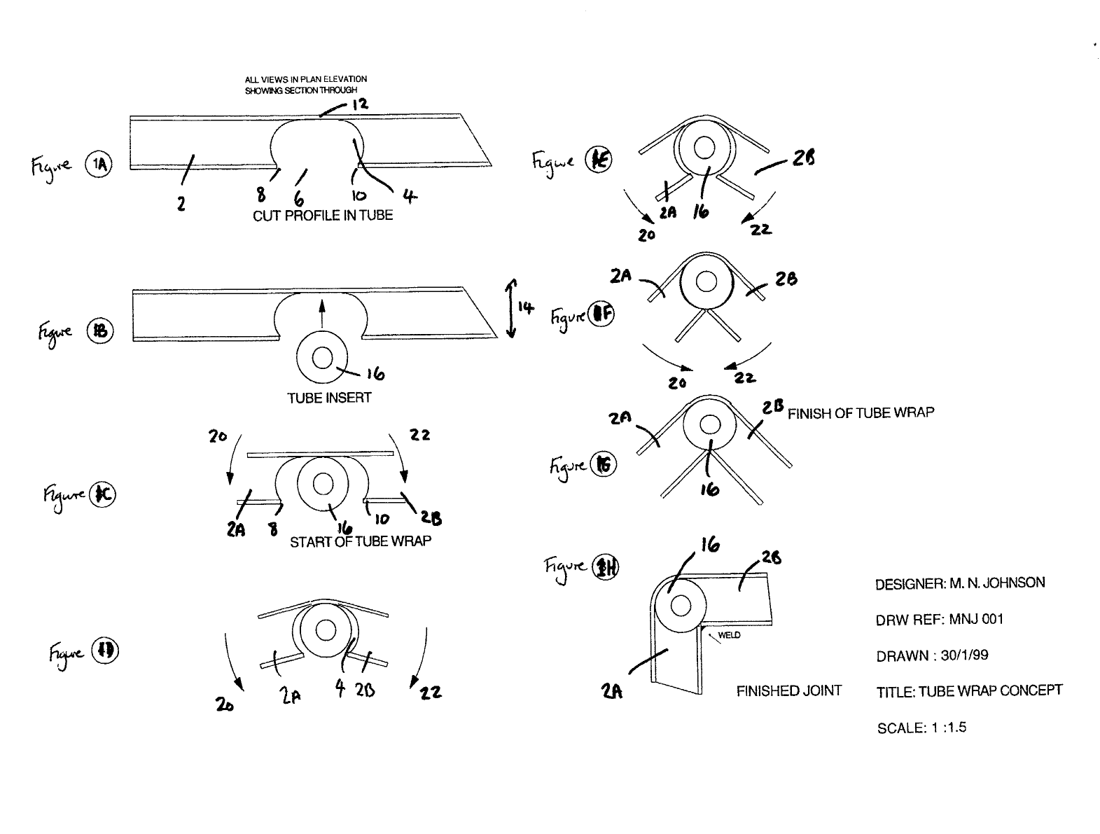

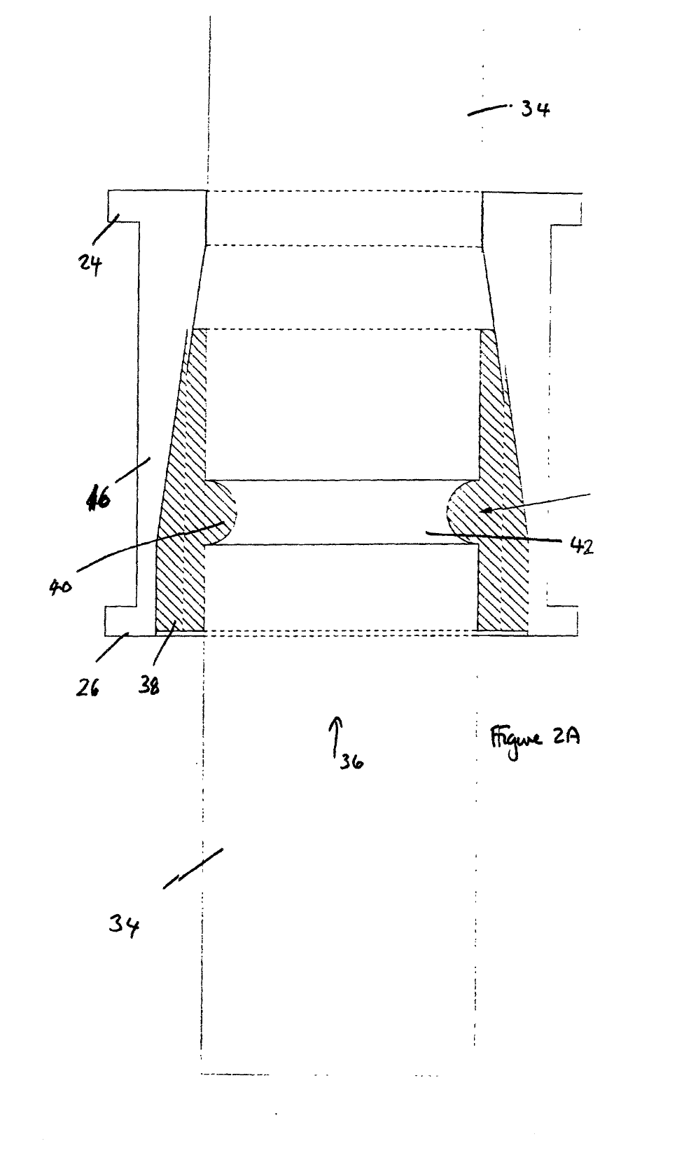

FIGS. 1A-H illustrate the method used in the formation of a joint in one embodiment according to the invention;

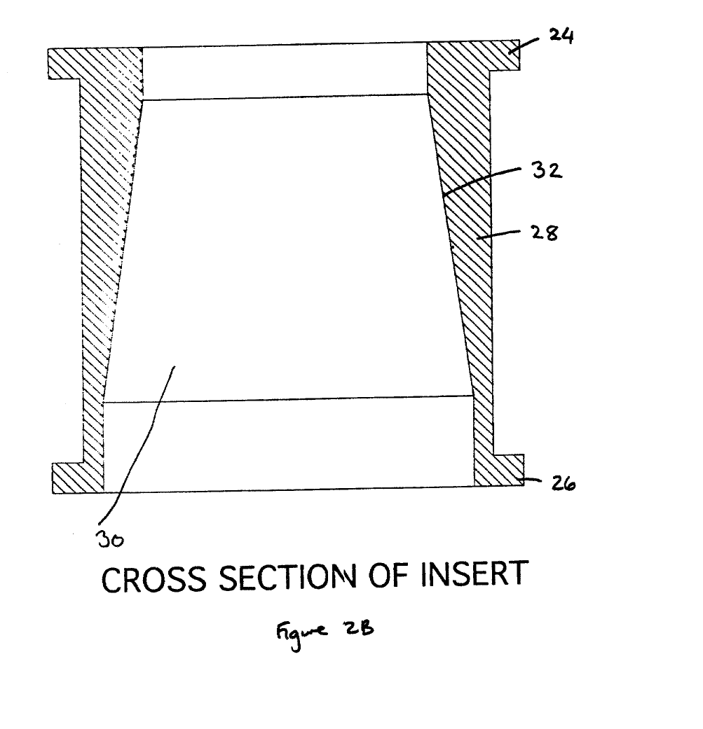

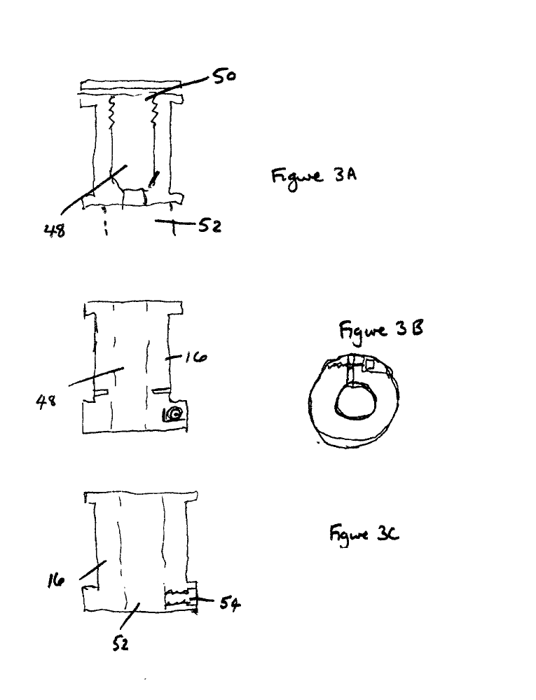

FIGS. 2A-B illustrate an embodiment of the joint with a second member attached therewith;

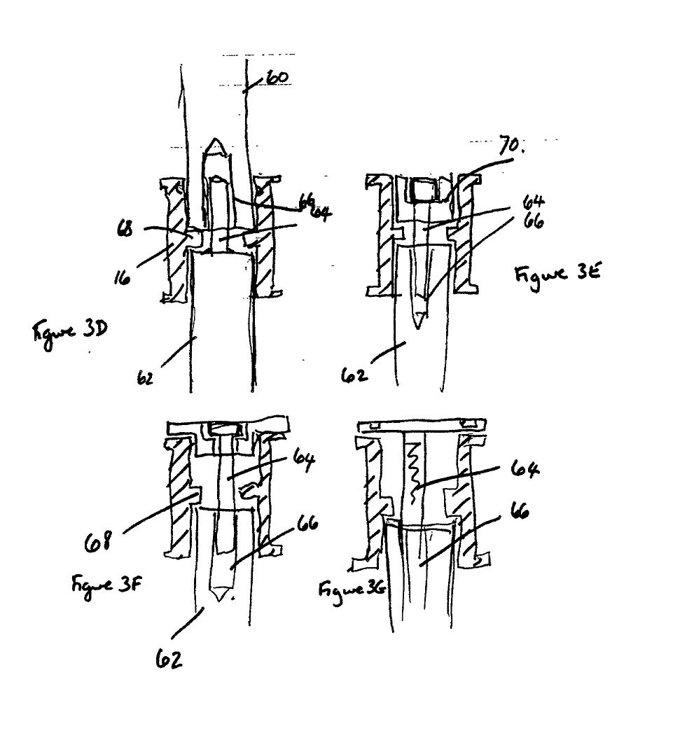

FIGS. 3A-G illustrate further arrangements of location means for a second member;

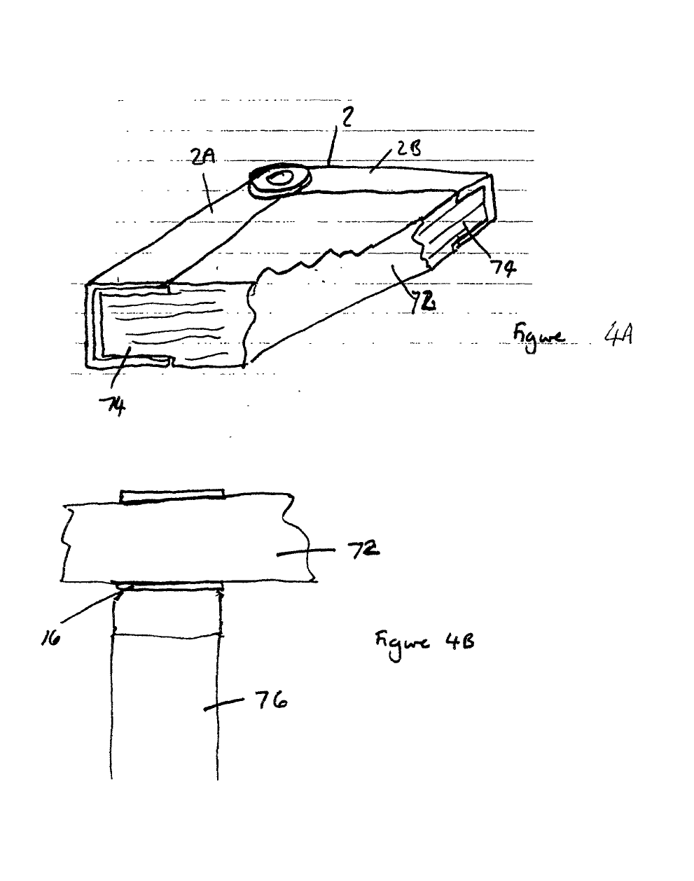

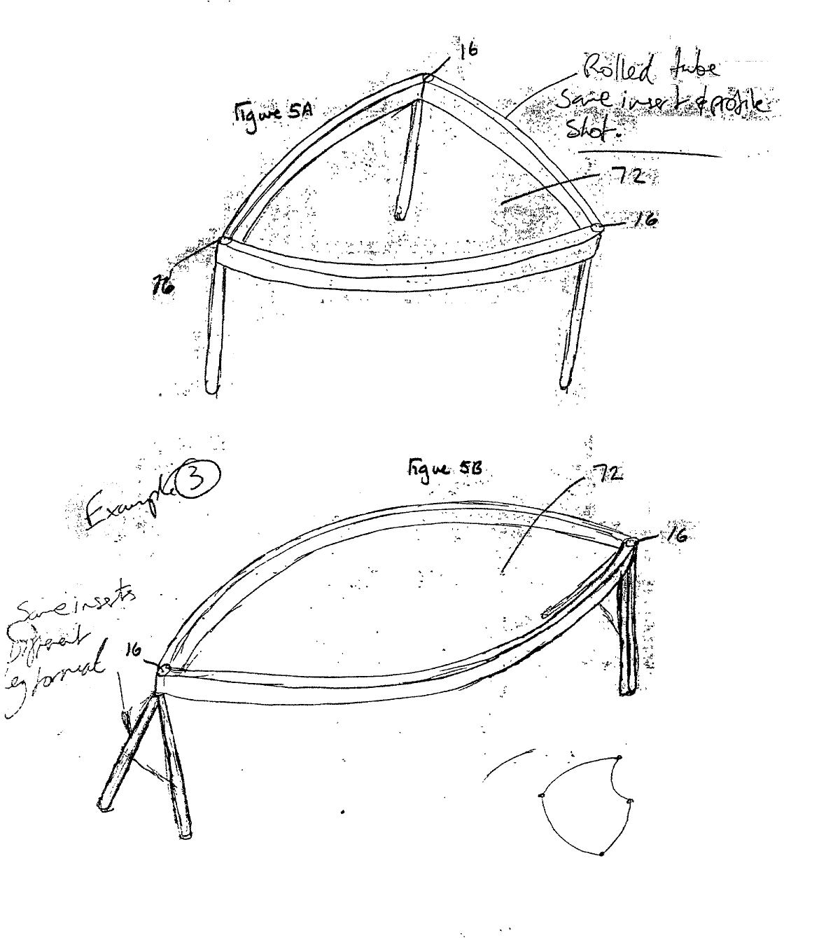

FIGS. 4A-B illustrate one use of a joint arrangement;

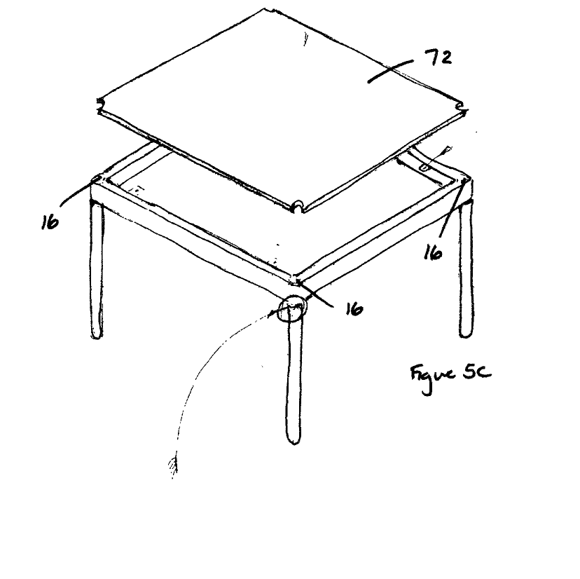

FIGS. 5A-C illustrate embodiments of some articles manufactured using the joint of the current invention.

Referring firstly to FIGS. 1A-H, there is illustrated a method of forming a joint in accordance with the current invention. There is provided in FIG. 1A a member 2 which can be tubular and typically of square or rectangular cross-section or may alternatively be of C-section or any appropriate section to suit the particular use. The material used can also be of any particular form and to suit particular manufacturing requirements and/or finishing appearances. There is formed in the member 2, which is shown in plan, an aperture 4 which has an opening 6 defined by first and second edges 8, 10. The aperture is formed so as to leave a band 12 of material of the member at the edge opposite the opening as illustrated.

FIG. 1B illustrates how an insert as shown, former piece or the second member to be attached thereto, is positioned in the aperture 4. In the embodiment shown the insert has a smaller diameter than the width 14 of the member 2 but it should be appreciated that the diameter of the insert could be greater than the width 14 thereby forming a bulbous joint. With the insert 16 in position as shown in FIG. 1C, the edges 8 and 10 are, in effect, wrapped around the insert 16 as is illustrated in FIG. 1D by the movement of the portions 2A, 2B of the member 2, illustrated by the arrows 20, 22 respectively. It will be seen with reference to FIGS. 1D through to G that the continued movement of the members 2A, 2B brings the edges 8 and 10 into a position in which they are adjacent one another and in which the walls of the aperture 4 wrap round and take significantly the same form as the outer surface of the insert 16. It should be noted that in normal instances the shape of the aperture will be such as to allow the formation of the aperture when the steps illustrated in FIGS. 1A-G have been completed substantially matches the outline of the insert 16. Thus the insert 16 can no longer be removed through the opening and the mechanical joint is formed and into which a second member, not shown, can be engaged. The insert 16 includes engagement means with which the second member engages. If required, the edges 8 and 10 can be welded together as illustrated in FIG. 1H to close the opening although this may not be necessary in all instances and, it will be appreciated that the position of the weld is such that it will not be readily viewable by onlookers to the article formed using joints of this type. It will therefore be appreciated that the joint formed in accordance with this invention does not require large scale welding or joining of components together and therefore the visual appearance of the joint so formed is greatly enhanced in comparison to conventional joints. Furthermore, there is no need to provide finishing operations on the joint to improve the visual appearance of the same as is the case with conventional joints.

FIGS. 2A and B illustrate the provision of one embodiment of insert 16 as part of the mechanical joint. The cross sectional view in FIG. 2B shows that the insert has upper and lower collars 24, 26 respectively which lie outside of the member 2 and prevent the insert from slipping through the aperture 4, and an outer wall 28 which defines an inner passage 30 which has a frustoconical portion 32. To allow the engagement of a second member 34 with the mechanical joint in this embodiment, the insert is positioned in the joint as described with FIGS. 1A-H and then the second member 34 is introduced into the insert as indicated by arrow 36 along with an engagement formation 38 which sits in the passage 30 of the insert 16. The engagement means 38 has an annular ring 40 which engages in an indented recess 42 in the second member 34 and thereby engages the second member in the insert via the engagement means 38 as shown. Typically, the second member can be a leg of a table, a desk, seat, shelving unit, staging or the like and in the embodiment of FIG. 2A, the second member 34 is engaged with the insert 16 and passes through the joint to form a leg of a shelving system so that the member will be engaged with a number of mechanical joints at spaced intervals there-along, each of the mechanical joints being provided at the location of a shelf.

There are a number of different arrangements of inserts which can be used to suit specific requirements and FIGS. 3A to G illustrate various embodiments. In FIG. 3A, the insert is provided with a threaded passage 48 into which a screw or other threaded engagement means 50 can be entered to engage with a member, not shown, but protruding from the base 52 of the insert. FIG. 3B illustrates a split collar form of insert with which a member can be engaged by passing into the aperture 48 passing through the insert. FIG. 3C utilises the provision of a grub screw 54 which can be used to engage with a second member 52 on the insert 16. FIG. 3D illustrates an arrangement whereby the insert 16 is provided to locate two members 60, 62 with respect to the mechanical joint and to each other by use of matching male and female engagement means 64, 66 and collar section 68 as illustrated. FIG. 3E illustrates a similar arrangement to FIG. 3D with only one member 62 being located and with a capped engagement portion 70 but utilising the male and female engagement means 64, 66 in a similar manner. FIGS. 3F and G illustrate similar arrangements to that of FIG. 3E.

It will be appreciated that a number of mechanical joints will typically be required to allow the formation of an item and it will also be appreciated that there are number of different embodiments of articles which can be formed using the mechanical joint as herein described.

FIGS. 4A and B illustrate one form wherein a mechanical joint is formed from member 2A, 2B and the member is provided with a C section as illustrated. The mechanical joint in this arrangement is provided to be used to form a table or staging and a portion of the sheet material used to form the table top or stage 72 is illustrated wherein recessed edges 74 are provided which engage in the recess of the C section as illustrated. With the leg 76 engaged in the insert 16 as shown in FIG. 4B, it will be appreciated how a number of said mechanical joints at the corners of the item are used to allow attachment of the legs and also, in conjunction with the members 2, allow the engagement of the sheet material 72 and so form the item.

FIGS. 5A to C illustrate alternative arrangements using mechanical joints, and FIGS. 5A and B illustrate how relatively unusually shaped items of furniture can be formed. Indeed, in the FIGS. 5A and B it is possible that the table top 72 can be provided in grooves along the inner sides of the member 2 and the member 2 formed around the shape of the table top with the joints formed at the same time as the member is shaped. FIG. 5C illustrates a more conventionally shaped table and illustrates how the table top is provided to be fitted into a frame formed with mechanical joints in accordance with the invention.

1. A mechanical joint for use in the construction of an article, said joint comprising a first member for connection with a second member, and wherein said first member is provided with at least one aperture having an opening defined by first and second edges, said aperture provided for the reception of the second member, or an insert to which the second member can be attached, and to form the joint, the first and/or second edges of the opening are moved to engage the second member or insert within the aperture.

2. A mechanical joint according to claim 1 characterised in that the first member is provided with a series of apertures formed at spaced intervals and each of said apertures is provided for the formation of a mechanical joint in accordance with the invention.

3. A mechanical joint according to claim 1 characterised in that the second member lies in a plane substantially perpendicular to the plane of the longitudinal axis of the first member.

4. A mechanical joint according to claim 1 characterised in that the first member is provided in an initial condition in an elongate form and the movement of the first and second edges of the opening of the aperture is about a pivotal axis located in the aperture or adjacent thereto so that the first member, when the joint is formed has relatively angled first and second portions at or adjacent to the formed joint.

5. A mechanical joint according to claim 1 characterised in that the aperture is formed so as to extend from one side of the member substantially across the majority of the member to the opposite side leaving a band of material at the opposite side.

6. A mechanical joint according to claim 1 characterised in that an insert is provided in the aperture and has upper and/or lower collars formations which protrude above or below the first member.

7. A mechanical joint according to claim characterised in that in one form the second member positioned in the aperture is a former and is subsequently moved out of the aperture and replaced by an insert which can be held in position.

8. A mechanical joint according to claim 1 characterised in that the second member is attached to an insert held within the opening.

9. A method of forming a mechanical joint, said method comprising taking a first elongate member, forming an aperture depending from one edge of said member, positioning a member or insert in the aperture and then moving at least one portion of the member to move first and second edges of the opening towards one another to a degree which is sufficient to prevent the insert or member from passing through the opening.

10. A method according to claim 9 characterised in that the first and second edges are respectively moved so as to substantially close the opening and hence retain the member or insert in position in the aperture.

11. A method according to claim 9 characterised in that the opening is completely closed by the provision of a closing member and/or weld material.

12. A method of forming a mechanical joint, said method comprising taking a first elongate member, forming an aperture depending from one edge of said member, positioning a former in the aperture and moving at least one portion of the member to at least partially close the opening to an extent which is sufficient to prevent the former from passing through the opening.

13. A method according to claim 12 characterised in that the former is removed by sliding the same out of the aperture and replaced by an insert or second member which is positioned to engage in the opening and so engage a second member with the first member directly or via the insert.

14. A method according to claim 12 characterised in that the former is an insert which is retained in position and to which the second member is connected.

15. A method according to claim 12 characterised in that the former is part of the second member trapped in position to form the mechanical joint.

16. An item formed from at least a first and second member, said item formed by engaging the second member with the first member via a mechanical joint and characterised in that said mechanical joint is formed with the first member including an opening defined therein for the reception of the second member or means to which the second member can be attached, said edges defining the opening moved to trap the means or second member in the opening and thereby form the item of furniture.

17. An item according to claim 16 characterised in that the item is formed from a series of selectively engaged members, at least one of said engagements made via a mechanical joint as herein described.
